(19) United States
(12) Patent Application Publication
(10) Pub. No.: US 2005/0099803 A1
(43) Pub. Date: May 12, 2005

(54) Lantern with swivel handle connected to lamp

(75) Inventor: Michael Krieger, Miami Beach, FL (US)

Correspondence Address: VENABLE, BAETJER, HOWARD AND CIVILETTI, LLP, P.O. BOX 34385, WASHINGTON, DC, 20043-9998, US

(73) Assignee: Vector Products, Inc., Ft. Lauderdale, FL (US)

(21) Appl. No.: 10/731,113

(22) Filed: Dec. 10, 2003

Related U.S. Application Data
(63) Continuation-in-part of application No. 10/702,480, filed on Nov. 7, 2003, now abandoned.

(51) Int. Cl. F21L 4/00

(52) U.S. Cl. 362/183

(57) ABSTRACT

A portable rechargeable electric lantern comprises: a head lamp; a handle coupled to the head lamp; a base coupled to the handle by a pivot coupling; a cavity housing an AC connector in the base; an AC-to-DC adapter housed in the base and coupled to the AC connector; and a rechargeable battery housed in the base and coupled to the AC-to-DC adapter, where the battery is recharged when the AC connector is coupled to an AC power source.

### CROSS-REFERENCE TO RELATED APPLICATIONS

This application is a continuation in part of U.S. patent application Ser. No. 10/702,480 file Nov. 7, 2003, which is incorporated herein by reference.

### BACKGROUND OF THE INVENTION

1. Field of the Invention

The present invention relates to a portable rechargeable electric lantern.

2. Related Art

There are a number of different portable rechargeable lanterns available. Conventional rechargeable lanterns, however, usually require a special power cord containing a built-in AC-to-DC adapter in order to recharge a battery housed in the lantern. If the user loses the specialized cord, or confuses the cord with another similar cord for another rechargeable appliance, the conventional lantern becomes useless.

Additionally, conventional lanterns are typically one integral unit, requiring the user to position the entire lantern, or to hold it in awkward or unstable positions in order focus the light where it is needed. Some lanterns have swiveling lamps, but this requires the user to handle the lamp itself to position the light. Lamps used for illumination can get hot or the user may otherwise damage the lamp while handling it. Further, other lanterns are provided with a foldable stand. However, when the stand is deployed, the entire weight of the lantern, including the battery, rests on the stand, which renders the configuration top-heavy and unstable.

Therefore, there is a need for a portable rechargeable lantern that is both easy to recharge and easy to position for optimum light placement.

### SUMMARY OF THE INVENTION

In an exemplary embodiment, a portable rechargeable electric lantern is provided, which comprises: a head lamp; a handle coupled to the head lamp; a base coupled to the handle by a pivot coupling; a cavity housing an AC connector in the base; an AC-to-DC adapter housed in the base and coupled to the AC connector; and a rechargeable battery housed in the base and coupled to the AC-to-DC adapter, where the battery is recharged when the AC connector is coupled to an AC power source.

In another embodiment of the invention, a portable rechargeable electric light is provided. The light comprises a first housing; an AC connector disposed on said housing; a second housing disposed within said first housing; a AC-to-DC converter circuit disposed within said second housing and coupled to said AC connector; a rechargeable power supply disposed in said first housing and coupled to said AC-to-DC adapter, wherein said battery is recharged when said AC connector is coupled to an AC power source; and a light source coupled to said rechargeable power supply.

In another embodiment of the invention a rechargeable light source comprises a first housing defining a cavity therein; a rechargeable power supply disposed in said cavity; a light source selectively coupled to said rechargeable power supply; and an AC-to-DC adapter disposed in said cavity and permanently coupled to said rechargeable battery, said AC-to-DC adapter including a second housing and converter circuitry.

Further features and advantages of the invention, as well as the structure and operation of various embodiments of the invention, are described in detail below with reference to the accompanying drawings.

### BRIEF DESCRIPTION OF THE DRAWINGS

FIG. 1 illustrates a perspective view of a portable lantern with a swivel handle in a closed position according to an embodiment of the invention;

FIG. 2 illustrates a side view of the portable lantern of FIG. 1 with the swivel handle in a closed position;

FIG. 3 illustrates a perspective view of a portable lantern with a swivel handle in an open position according to an embodiment of the invention;

FIG. 4 illustrates a bottom view of a portable lantern according to an embodiment of the invention; and

FIG. 5 illustrates a rear view of a portable lantern according to an embodiment of the invention.

### DETAILED DESCRIPTION OF THE INVENTION

An embodiment of the invention is discussed in detail below wherein like reference numbers generally indicate identical, functionally similar, and/or structurally similar elements. While specific exemplary embodiments are discussed, it should be understood that this is done for illustration purposes only. A person skilled in the relevant art will recognize that other components and configurations can be used without departing from the spirit and scope of the invention.

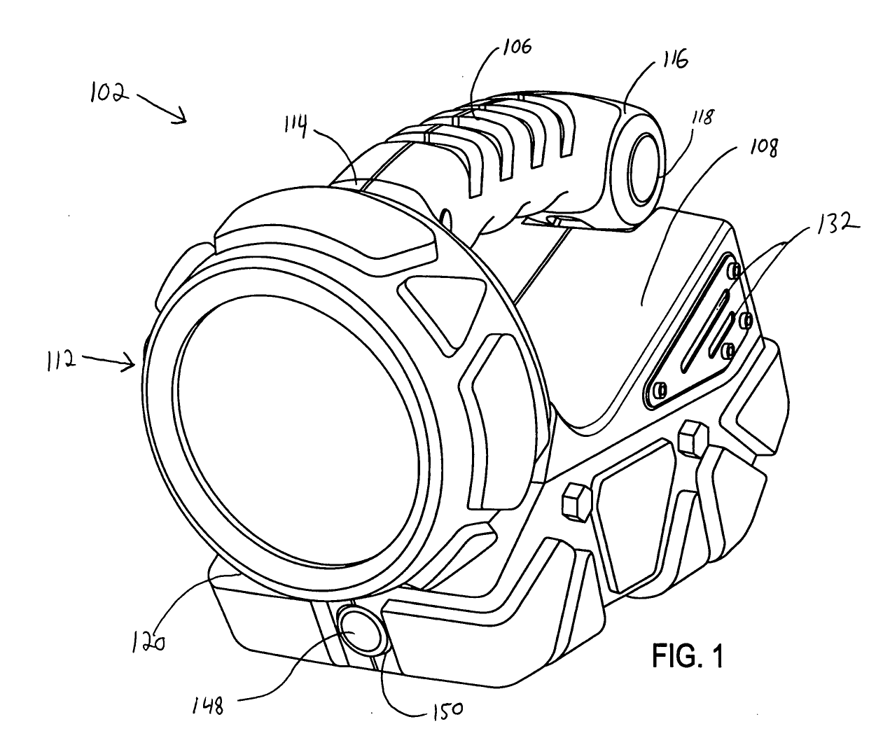

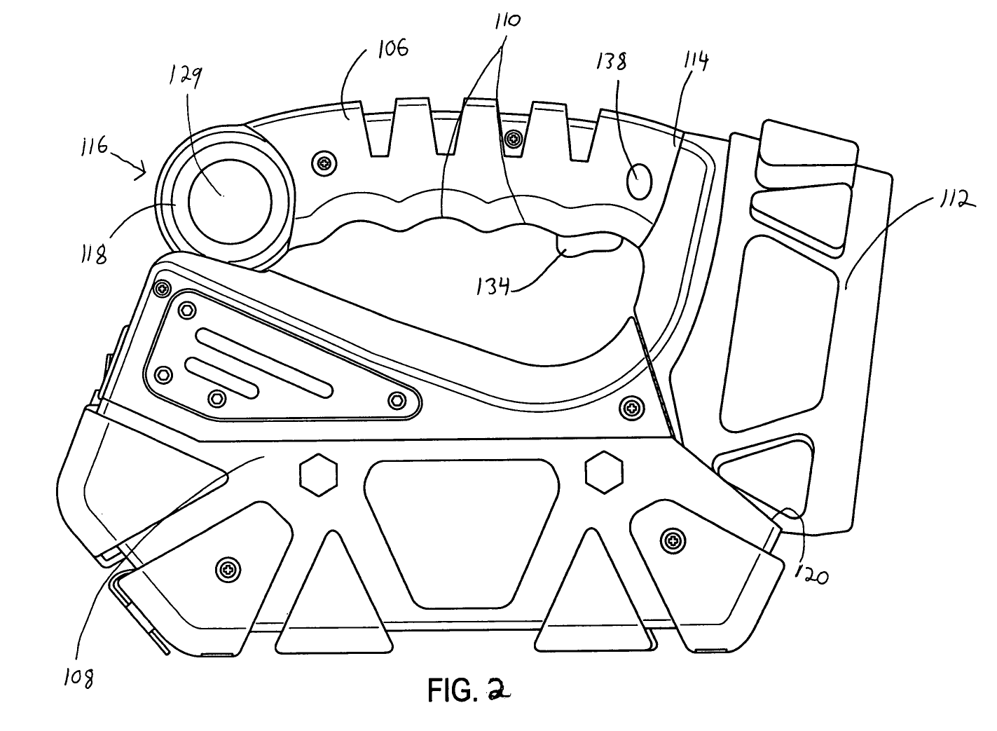

FIGS. 1 and 2 illustrate a perspective and a side view of an exemplary portable rechargeable electric lantern 102 according to the present invention. The lantern 102 has a housing comprising a handle 106 coupled to a base 108. The handle 106 may be provided with grooves on its underside. The grooves are sized and shaped to receive the fingers of a user and form finger grips 110 on the bottom side of the handle 106. The handle 106 may also be at least partially covered with a shock absorbent material or other material to improve the gripability of the handle 106.

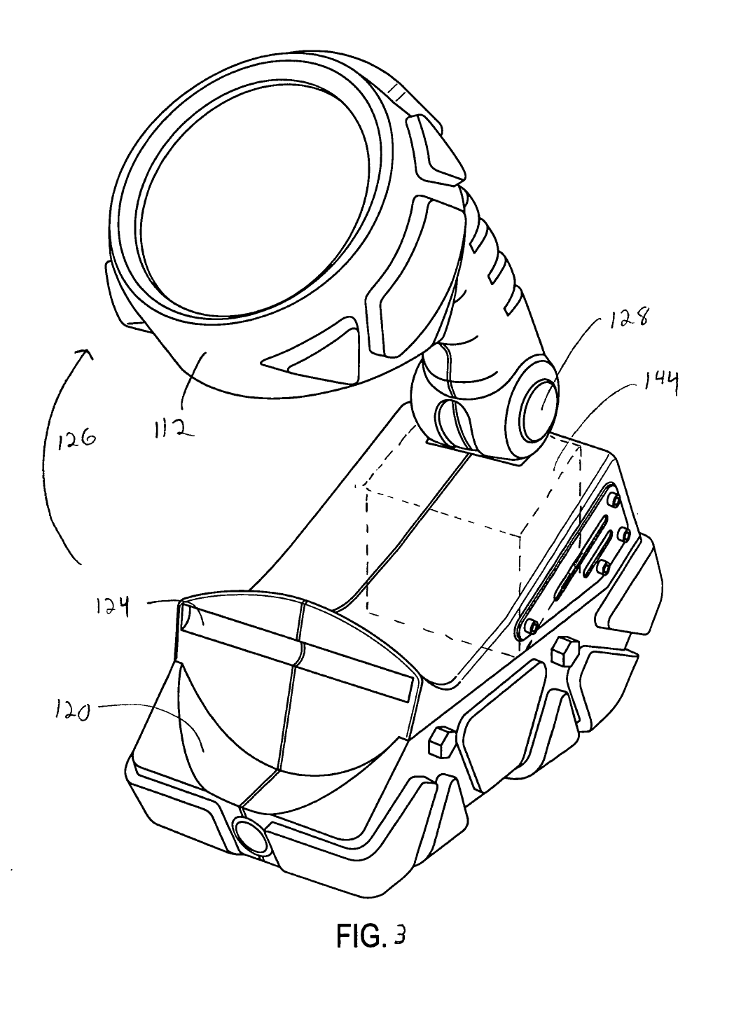

A lamp head 112 is disposed at a first end 114 on the handle 106. The lamp head may include a lamp, reflector, lens, bezel, and other typical flashlight components (not shown). The lamp may be an incandescent lamp, a halogen lamp, a fluorescent lamp, a light emitting diode or any other type of lighting element. The lamp head 112 is releasably associated with the base 108. A second end 116 of the handle 106 opposite the lamp head 112 is coupled to the base 108 of the lantern 102 with a pivot coupling 118. The lamp head 112 may be pivoted about pivot coupling 118 between two positions, a raised position and a lowered position. FIGS. 1 and 2 illustrate the lamp head 112 in a lowered position. In the lowered position, the lamp head 112 is received by base 108. Handle 106 is spaced from base 108 to allow a user to grasp handle 106. The base 108 includes a recess 120 configured to receive the lamp head 112. (See FIG. 3) A tab (not shown) may be provided on a bottom surface of lamp head 112. A corresponding slot 124 is provided on the base 108 to receive the tab. The lamp head may rest on the base 108 in the lowered position.

FIG. 3 illustrates the lamp head 112 in a raised position. Here, the lamp head 112 is moved from the lowered position in the direction of arrow 126 to the raised position. The lamp head 112 and first end 114 of the handle 106 move away from base 108 about pivot coupling 118. Second end 116 of handle 106 remains coupled to the base 108. The lamp head is moved until it reaches the raised position, at which point it may be automatically locked into place. In the raised position, the lamp head 112 and handle 106 form an angle of about 45-degrees with respect to the base 108. Of course, the lamp head can be positioned at other angles in the raised position.

The lamp head 112 may be locked into either of the lowered position or the raised position. When the lamp head 112 reaches one of these extreme positions, pivot coupling 118 may be automatically locked into place. Pivot coupling 118 may include a spring pressure mechanism. The spring pressure mechanism is configured to lock the handle 106 into place when the handle 106 reaches selected positions, here the lowered and raised positions. The pivot coupling 118 includes buttons 128, 129 disposed on either side. Button 128 pops out when the lamp head 112 reaches an extreme position and the lamp head 112 is locked into place. This indicates that the lamp head 112 is secured into position. The lamp head 112 can be unlocked and moved again by depressing button 128. This deactivates the locking mechanism allowing the lamp head 112 and handle 106 to be moved. When the lamp head 112 reaches one of the lowered or raised positions, spring pressure lock mechanism is activated and the lamp head 112 is locked into place.

Pivot coupling 118 allows the lamp head 112 and handle 106 to be secured in the lowered position as shown in FIGS. 1 and 2. In the lowered position, handle 106 is substantially parallel to a bottom surface of the base 108. When in the lowered position, the handle 106 can be used to transport the lantern. The pivot coupling 118 secures the handle 106 in place so that the handle 106 does not accidentally slip and move to the raised position while the lantern is being carried or handled by a user.

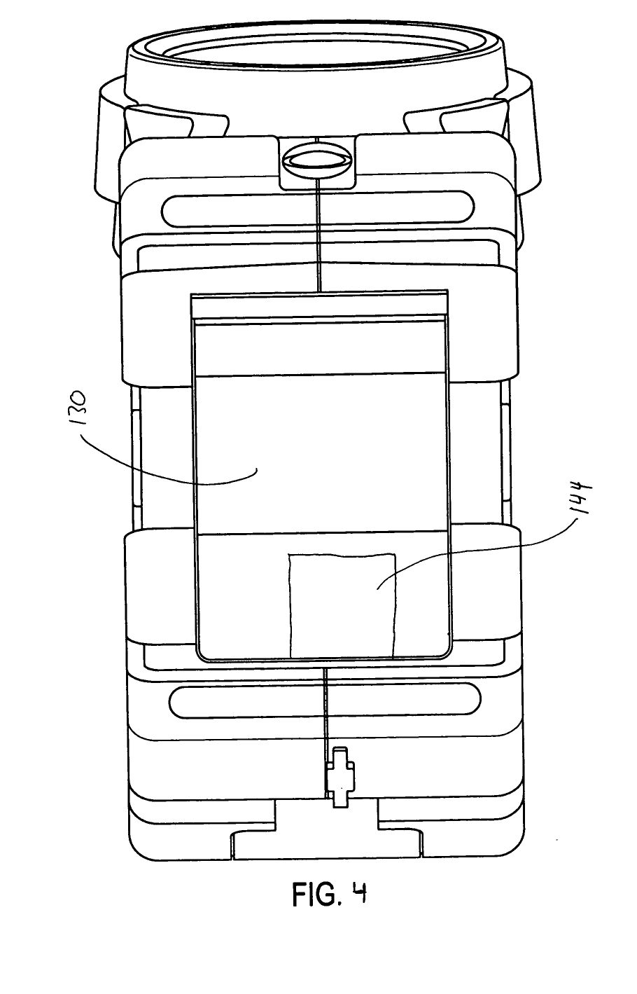

Referring now to FIG. 4, a power supply 130 may be housed in a cavity in the base 108. The power supply 130 is preferably rechargeable, such as a rechargeable battery. The battery is preferably arranged with the battery's length perpendicular to the length of the base 108. Base 108 is provided with vents 132 that allow any gas generated during the battery recharging process to escape from the interior of the base 108. Circuitry coupling the power supply 130 to the lamp in lamp head 112 may be provided in the base 108 and handle 106. For example, a power switch 134 may be provided on the handle 106. In the embodiment illustrated, switch 134 is provided on a bottom side of handle 106. Switch 134 is coupled to the battery in the base 108 and to a lamp in the lamp head 112. Switch 134 is provided for a user to actuate the lamp. Switch 134 may be a so-called “dead man's switch”, that is, the switch must be held in the actuated position in order to illuminate the lamp. Switch 134 may include a biasing means, such as a spring. Once a user's finger is removed from the switch, the biasing means opens the switch.

In an embodiment of the invention, a means for securing the switch in the on position, allowing hands. free operation of the lantern, is provided. Button 138 is provided on the handle 106 for this purpose. Switch 134 is depressed to illuminate lamp. Button 138 extends through the handle 106 perpendicular to a longitudinal axis of the handle 106. Button 138 is pressed while switch 134 is in the depressed position. A hook or some other mechanism engages the switch 134 and holds switch 134 in the depressed position. When button 138 is moved in the opposite direction, switch 134 is released and the biasing means is able to return the switch 134 its normally-off position.

As mentioned above, the power supply is preferably rechargeable. Therefore, a recharging circuit is coupled to the power supply 130. Power to recharge the power supply is provided through the recharging circuit. The recharging circuit may be coupled to a recharging power source in order to recharge the power supply 130. Preferably, the recharging circuit is configured to receive both of an AC and a DC input.

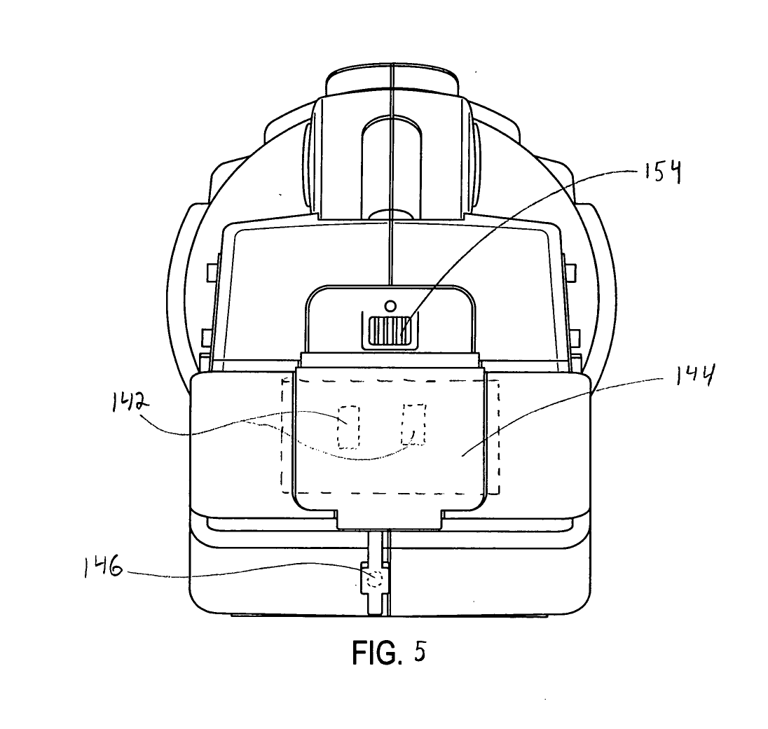

For example, an AC input device may be provided on base 108. As shown in FIG.5, a rear of the base 108 defines a cavity 140 containing an AC connector, for example, AC prongs 142. The AC connector 142 is adapted to receive an AC input for recharging the power supply. An AC-to-DC adapter 144 is provided to convert the AC input into DC power for recharging the battery (FIGS. 3 and 5). The AC-to-DC adapter 144 may be of a known type, such as a standard wall cube or discrete circuit components arranged on a printed circuit board. The AC-to-DC adapter 144 is preferably arranged within base 108.

Additionally, the AC-to-DC adapter 144 is substantially enclosed by a first housing. The first housing encloses the adapter circuitry and may be, for example, the housing of a wall cube. The AC-to-DC adapter 144 and its housing should meet the applicable standards for power units such as those promulgated by Underwriters Laboratory, for example UL 1310 standard for power units and UL 94 V1 standard for fire rating. AC-to-DC adapter 144 is also arranged within an exterior housing, such as base 108. The AC-to-DC adapter circuit is thus substantially enclosed by two housings. The first housing may be housing 144 that may be part of a standard wall cube adapter. The second housing may be the housing for the lantern or other light source. Incorporating the AC-to-DC adapter 144 along with its adapter housing internal to the lantern housing allows the lantern to meet applicable UL standard without the need for the entire lantern housing to be rated.

Battery 130 is preferably permanently coupled to the AC to DC adapter 144. AC connector 142 is adapted to be plugged into one end of a typical household extension cord. An opposite end of the extension cord with a plug is adapted to be plugged into a typical wall outlet. When an AC power cable is connected between an AC power source, for example, a wall outlet, and to the AC connector 142, the battery 130 within the base 108 is recharged. Accordingly, the user may advantageously use any standard household extension cord to plug the lantern into a standard wall outlet for recharging, rather than having to use a custom-made power cord having an external AC-to-DC adapter.

The lantern may also accommodate a DC recharging power supply. Thus, a DC input may also be provided. The DC input can receive power input from a standard wall cube or other DC power source. A port 146 is provided on the rear of base 108 to receive the DC input.

A second light source 148 may also be provided. The second light source 148 may provide a lower intensity light compared with the lamp in lamp head 112. The second light source 148 may be a light emitting diode (LED). The second light source 148 may be arranged at any location, for example either in the lamp head 112 or in the base 108. Preferably, the LED is disposed in the base 108. In the embodiment illustrated, the base 108 is provided with a recess 150 to receive the LED. The recess 150 is arranged in the base 108 under the lamp head 112 when the lamp head 112 is in the lowered position. Accordingly, the recess 150 is spaced a distance from recess 120 receiving the lamp head 112. Thus, when the lamp head 112 is moved between it raised and lowered positions, the secondary light source does not move. Also, the lamp and the second light source 148 project a beam of light in the same general direction when the lamp head is in the lowered position. The lamp head 112 and second light source should be arranged so as not to interfere with each other.

The second light source 148 is coupled to the power supply 130 disposed in the base 108. A switch 154 on a rear surface of the base 108 is used to illuminate the second light source 148. The switch 154 is preferably separate from switch 134. However, a single switch can be provided to actuate both the lamp and second light source.

FIG. 3 illustrates the portable lantern 102 in an opened position according to a preferred embodiment of the invention. The lantern 102 remains steady regardless of the position of the head lamp 112 by resting on the base 108. The user can use the handle 106 to position the head lamp 112 without having to handle 106 the lamp 112 directly.

A bottom portion of the base 108 may be provided with a shock absorbent material, such as a rubber-like material. The shock absorbent material may be arranged in a pattern along the bottom of the base 108. The pattern may include polygon-shaped protrusions separated by channels. The material may also be provided around the bezel of lamp head 112. The material protects the lantern from damage due to rough treatment.

Although an embodiment of the invention is described above as a lantern having a base, other embodiments also possible within the scope of the invention. For example, the portable light may be a flashlight having a housing with a tubular construction, as is typical of many handheld flashlights. The portable light may take essentially any form such as a spotlight, table lamp, among many others. The housing for the portable light should be able to contain an AC to DC adapter. Also, as mentioned above, the lighting element can take many various forms.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

1-13. (canceled)

14. A portable rechargeable electric light comprising:
a first housing;
a rechargeable power supply disposed in said first housing;
a light source coupled to said rechargeable power supply; and
an AC-to-DC converter disposed within said first housing and being coupled to the rechargeable power supply, the AC-to-DC converter including an AC connector arranged for being connected to an external power cord for delivering AC power to the AC-to-DC converter for recharging the rechargeable battery.

15. The portable light according to claim 14, wherein the AC-to-DC converter includes a second housing and AC to DC converter circuitry disposed within the second housing.

16. The portable light of claim 14, wherein the AC connector comprises prongs.

17. The portable light of claim 15, wherein the AC-to-DC converter circuit and prongs comprises a wall cube.

18. The portable light of claim 16, wherein the second housing meets UL standard 1310.

19. The portable light of claim 16, wherein the second housing meets UL standard 94 V1.

20. The portable light of claim 14, further comprising a handle having a first end and a second end, the second end being pivotably coupled to the first housing.

21. The portable light of claim 20, wherein the light source is disposed on the handle.

22. The portable light of claim 21, wherein the handle with said light source are pivotable between a raised position and a lowered position relative to the first housing.

23. The portable light of claim 16, wherein the first housing substantially encloses the second housing.

24. The portable light of claim 16, wherein the second housing substantially encloses said AC-to-DC converter circuit.

25. A rechargeable light source, comprising:
a first housing defining a cavity therein;
a rechargeable power supply disposed in the cavity;
a light source selectively coupled to the rechargeable power supply; and
an AC-to-DC adapter disposed in the cavity and coupled to the rechargeable power supply, the AC-to-DC adapter including a second housing and converter circuitry.

26. The light source of claim 25, wherein the first housing substantially encloses the second housing.

27. The light source of claim 25, wherein the AC-to-DC adapter comprises a wall cube.

28. The light source of claim 25, wherein the second housing meets UL standard 1310.

29. The light source of claim 25, wherein the second housing meets UL standard 94 V1.

30. The light source of claim 25, further comprising:
a handle having a first end and a second end; and
a pivot coupling joining said second end of handle to said housing so that the handle can be pivoted between at least one raised position and a lowered positon relative to the first housing.

31. The light source of claim 30, wherein the pivot coupling further comprises a lock, the lock being configured to lock the handle in the at least one raised position and in the lowered position.

32. The light source of claim 31, wherein the lock comprises a spring lock pressure mechanism.

33. The light source of claim 30, wherein the light source is disposed on the handle.

34. The light source of claim 25, further comprising a second light source disposed on the housing.

35. The light source of claim 2512, further comprising a switch arranged on the handle, the switch making and breaking a connection between the light source and the power supply.

36. The light source of claim 32, further comprising a locking mechanism disposed on the handle, the locking mechanism for being actuated by a user to interact with the switch to lock the switch in an on position.
